(19) United States
(12) Patent Application Publication
(10) Pub. No.: US 2002/0008839 A1
(43) Pub. Date: Jan. 24, 2002

(54) Method for producing liquid crystal display elements

(76) Inventors: Mitsuyoshi Miyai, Sakai-Shi (JP); Masakazu Okada, Kyoto-Shi (JP); Keiichi Furukawa, Suita-Shi (JP)

Correspondence Address: SIDLEY AUSTIN BROWN & WOOD, 717 NORTH HARWOOD, SUITE 3400, DALLAS, TX, 75201, US

(21) Appl. No.: 09/896,717

(22) Filed: Jun. 29, 2001

(30) Foreign Application Priority Data
Jul. 3, 2000 (JP) 2000-200929

(51) Int. Cl. G02F 1/1339

(52) U.S. Cl. 349/190

(57) ABSTRACT

Disclosed is a method of producing a plurality of LC display elements, each of the LC display elements including a first substrate, a second substrate and a seal wall, the seal wall being arranged between the first and second substrates, being adhered to both of the first and second substrates and being provided for sealing an LC. The method comprises the steps of: (a) forming at least one adhesive structure onto at least one of first and second sheets using at least one kind of adhesive material, the first sheet including a plurality of portions that are to be the first substrates for the plurality of the LC display elements, the second sheet including a plurality of portions that are to be the second substrates for the plurality of the LC display elements, at least a portion of said at least one adhesive structure being to serve as the seal walls for the plurality of the LC display elements to be produced; and (b) adhering the first and second sheets together with said at least one adhesive structure therebetween while applying a pressure along a predetermined pressure progression direction; wherein said at least one adhesive structure occupies, at every position with respect to the pressure progression direction in a range from an upstream end thereof to a downstream end thereof, at least a part of a gap between the first and second sheets after performing the adhering step.

### CROSS-REFERENCE TO RELATED APPLICATION

This application is based on Japanese Patent Application No. 2000-200929 filed in Japan on Jul. 3, 2000, the entire content of which is hereby incorporated by reference.

### BACKGROUND OF THE INVENTION

1. Field of the Invention

The present invention relates to a method of producing a plurality of liquid crystal display elements each having a seal wall formed between a pair of substrates and adhering thereto for sealing a liquid crystal, and more particularly to a method of producing a plurality of liquid crystal display elements from a pair of sheets (substrates) in so-called gang producing manner.

2. Description of Related Art

In a liquid crystal display element, a liquid crystal is held between a pair of substrates. Images are displayed by applying a voltage across electrodes formed on the substrates to change the orientation of liquid crystal molecules. In addition to the liquid crystal, a seal wall is usually arranged between the substrates for preventing a leakage of the liquid crystal. The seal wall adheres to each of the two substrates and surrounds the liquid crystal between these substrates.

In recent years, such a liquid crystal display element has been commercially provided in which polymer film substrates are used in stead of glass substrates for holding the liquid crystal.

The liquid crystal display element having the polymer film substrates has advantages of being lightweight and rarely broken compared with the liquid crystal display element having the glass substrates.

Various methods have been proposed for producing the liquid crystal display element having the polymer film substrates.

For example, Japanese Laid-open patent publication No. H11-326926 (326926/1999) proposes the method of producing the liquid crystal display element in which the two substrates are fixed or adhered together from one end portion of these substrates to the other end portion thereof with the liquid crystal and the seal wall therebetween while applying a pressure to these substrates from one end portion to the other end portion thereof. In this case, the two substrates are fixed to each other with the seal wall made of a sealing material. This method is capable of fixing flexible substrates with ease and precision.

When producing a plurality of the liquid crystal display elements, it can be envisaged that, for example, the producing method taught in Japanese Laid-open patent publication No. H11-326926 is applied to the production of the plurality of the liquid crystal display elements, and more specifically in the following manner. First, a pair of sheets (substrates) having a size required for producing a plurality of the liquid crystal display elements are prepared. Then, a plurality of seal walls are formed onto one of the sheets, and thereafter the sheets are fixed together from one end portion of these sheets to the other end portion thereof with the liquid crystals and the seal walls therebetween while applying a pressure from one to the other end portion of the sheets. Thereafter the sheets are cut along predetermined cut lines, whereby a plurality of liquid crystal display elements can be obtained.

This method, however, sometimes bring a shift of a positional relationship between the two sheets when these sheets are fixed together while applying the pressure from one end portion of the sheets to the other end portion thereof.

### SUMMARY OF THE INVENTION

An object of the invention is to provide a method of producing a plurality of liquid crystal display elements from a pair of sheets, each display element having a seal wall formed between a pair of substrates and adhering thereto for sealing a liquid crystal, and more particularly to provide the producing method in which a shift of a positional relationship between the sheets (substrates) can be suppressed when the sheets are fixed together with the seal walls therebetween while applying a pressure from one end portion of the sheets to the other end portion thereof.

The invention provides a method of producing a plurality of liquid crystal display elements, each of the liquid crystal display elements including a first substrate, a second substrate and a seal wall, the seal wall being arranged between the first and second substrates, being adhered to both of the first and second substrates and being provided for sealing a liquid crystal to be arranged between the first and second substrates, the method comprising:

(a) an adhesive structure forming step of forming at least one adhesive structure onto at least one of first and second sheets using at least one kind of adhesive material,

the first sheet including a plurality of portions that are to be the first substrates for the plurality of the liquid crystal display elements, the second sheet including a plurality of portions that are to be the second substrates for the plurality of the liquid crystal display elements, at least a portion of said at least one adhesive structure being to serve as the seal walls for the plurality of the liquid crystal display elements to be produced; and

(b) an adhering step of adhering the first and second sheets together with said at least one adhesive structure therebetween while applying a pressure along a predetermined pressure progression direction; wherein

said at least one adhesive structure occupies, at every position with respect to the pressure progression direction in a range from an upstream end thereof to a downstream end thereof, at least a part of a gap between the first and second sheets after performing the adhering step.

The foregoing and other objects, features, aspects and advantages of the present invention will become more apparent from the following detailed description and the accompanying drawings.

### BRIEF DESCRIPTION OF THE DRAWINGS

FIG. 1 is a schematic section view showing an example of the liquid crystal display element to be produced by the producing method of this invention.

FIG. 2 is a schematic perspective view of the liquid crystal display element of FIG. 1.

FIGS. 3(A) and 3(B) show an example of a configuration of an adhesive material supplied on each of the two sheets (substrates), or in other words, an example of a configuration of an adhesive structure formed on each of the sheets. FIG. 3(C) is a schematic side view of the adhesive material supplied on the sheet shown in FIG. 3(B) when viewed from the side of the sheet (substrate).

FIG. 4 is a view showing, by way of example, a state of the liquid crystal supplied onto the sheet (substrate).

FIG. 5 is a view showing an example of a manner of fixing the sheets (substrates).

FIG. 6 is a view showing cut lines for dividing the sheets into a plurality of liquid crystal display elements.

FIG. 7 is a view showing cut lines for exposing the electrodes by cutting off the sheet portion.

FIGS. 8(A) and 8(B) show another example of the configuration of the adhesive material supplied on each of the two sheets (substrates).

FIGS. 9(A) and 9(B) show a further example of the configuration of the adhesive material supplied on each of the two sheets (substrates).

FIGS. 10(A) and 10(B) show a still further example of the configuration of the adhesive material supplied on each of the two sheets (substrates).

FIGS. 11(A) and 11(B) show a still further example of the configuration of the adhesive material supplied on each of the two sheets (substrates).

FIGS. 12(A) and 12(B) show a still further example of the configuration of the adhesive material supplied on each of the two sheets (substrates).

FIG. 13 is a view showing another example of the manner of fixing the sheets (substrates).

FIG. 14 is a view showing a further example of the manner of fixing the sheets (substrates).

FIGS. 15(A) and 15(B) show another example of the configuration of the adhesive material supplied on each of the two sheets (substrates).

### DESCRIPTION OF THE PREFERRED EMBODIMENTS

### §1. First Type Producing Method

In the following description, a first type method of producing a plurality of liquid crystal elements is presented.

### §1.1.

The first type producing method is a method for producing a plurality of liquid crystal display elements, each of the liquid crystal display elements having a pair of substrates and a seal wall arranged between the substrates, the seal wall adhering to both of the substrates and being provided for sealing a liquid crystal to be arranged between the substrates, the method comprising the steps of:

(a) supplying an adhesive material in a predetermined configuration onto at least one of the substrates (adhesive material-supplying step); and

(b) fixing together the two substrates with the adhesive material therebetween while applying a pressure to the substrates from one end portion thereof to the other end portion thereof in a pressure progression direction (fixing step);

wherein

at least a part of the adhesive material to be supplied onto the substrate in the adhesive material-supplying step is used for forming the seal walls for the plurality of the liquid crystal display elements to be produced;

at least two seal walls in total are formed on the substrates using the adhesive material supplied on at least one of the substrates in the adhesive material-supplying step; and

the adhesive material is supplied onto at least one of the substrates in the adhesive material-supplying step so as that the adhesive material continuously adheres to the substrates in the pressure progression direction when the pressure is applied to the substrates from one end portion thereof to the other end portion thereof in the fixing step.

### §1.2

Each of the liquid crystal display elements produced by the first type producing method has a pair of substrates, i.e., first and second substrates as well as a seal wall. The liquid crystal display element to be produced has the following structure. The seal wall is arranged between the first and second substrates. The seal wall adheres to each of the first and second substrates and is made of an adhesive material (sealing material (sealer)). A liquid crystal is arranged in a space surrounded by the first and second substrates and the seal wall. The seal wall serves to prevent a leakage of the liquid crystal from the space between the substrates.

At least one liquid crystal display element produced by the first type producing method may further have one or more of spacers, one or more of resin structures (adhesive resin columns) and/or others. The spacer is to be arranged between the substrates for controlling a gap between the substrates to a predetermined value, or in other words, for controlling a thickness of the liquid crystal. The resin structure is also to be arranged between the substrates, and can be also used to control the gap between the substrates. The resin structure adhere to at least one of the substrates. The resin structure adhering to both of the substrates can increase the adhesion strength of the substrates and can prevent peel of the seal wall from the substrate.

What is described above on the liquid crystal display element is also true with respect to each of liquid crystal display elements produced by a second type producing method to be described later.

According to the first type producing method, a plurality of the liquid crystal display elements are produced at one time from first and second substrates (sheets) as described later in detail.

In the description given hereinafter, the first and second substrates having a size required to produce the plurality of the liquid crystal display elements are referred as first and second sheets, respectively. The first sheet has portions that are to be the first substrates for the plurality of the liquid crystal display elements to be produced. Similarly, the second sheet has portions that are to be the second substrates for the plurality of the liquid crystal display elements to be produced.

According to the above, the first type producing method described in the foregoing section §1.1. could read as follows:

a method for producing a plurality of liquid crystal display elements, each of the liquid crystal display elements having a pair of substrates and a seal wall arranged between the substrates, the seal wall adhering to both of the substrates and being provided for sealing a liquid crystal to be arranged between the substrates, the method comprising the steps of:

(a) supplying an adhesive material in a predetermined configuration onto at least one of sheets (adhesive material-supplying step); and

(b) fixing together the sheets with the adhesive material therebetween while applying a pressure to the sheets from one end portion thereof to the other end portion thereof in a pressure progression direction (fixing step);

wherein

at least a part of the adhesive material to be supplied onto the sheet in the adhesive material-supplying step is used for forming the seal walls for the plurality of the liquid crystal display elements to be produced;

at least two seal walls in total are formed on the sheets using the adhesive material supplied on at least one of the sheets in the adhesive material-supplying step; and

the adhesive material is supplied onto at least one of the sheets in the adhesive material-supplying step so as that the adhesive material continuously adheres to the sheets in the pressure progression direction when the pressure is applied to the sheets from one end portion thereof to the other end portion thereof in the fixing step.

In the first type producing method, the plurality of the liquid crystal display elements are produced from a pair of sheets in so-called gang producing manner. More specifically, a plurality of seal walls are formed onto at least one of the first and second sheets using the adhesive material before fixing the sheets. Then the first and second sheets are fixed together with the seal walls made of the adhesive material therebetween, and thereafter the sheets are cut and divided to provide the plurality of the liquid crystal display elements in independent forms.

In the first type producing method, the liquid crystal may be arranged in each the space surrounded by each of the seal walls, e.g., by supplying the liquid crystal onto the sheet before and/or during fixing the sheets as described later in greater detail. Or the liquid crystal may be arranged in each the space surrounded by each of the seal walls by filling the liquid crystal into the space after fixing the sheets. That is, in the first type producing method, so-called empty-liquid crystal display elements (empty cells) each in which the liquid crystal is not arranged in the space surrounded by the sheets (substrates) and the seal wall are produced firstly in some cases. The same is also true with respect to the second type producing method to be stated later.

The first type method for producing the liquid crystal display elements includes the adhesive material-supplying step and the fixing step. It is a matter of course to prepare the required materials such as sheets (substrates) before conducting each step.

If employing the supply of the liquid crystal onto the sheet before fixing the sheets as described above, the following liquid crystal-supplying step may be further performed. If employing the filling of the liquid crystal into the space surrounded by the seal wall after fixing the sheets, the following liquid crystal-filling step may be further performed. If employing the spacer(s) to be arranged between the substrates, the following spacer-supplying step may be further performed. If employing the resin structure(s) to be arranged between the substrates, the following resin structure-forming step may be further performed. These steps are explained below.

(a) Preliminary Step (Preparation Step)

In producing the liquid crystal display elements by the first type producing method, at least a pair of sheets and an adhesive material (sealer) for forming seal walls are required.

At least one of the paired sheets (at least one of the first and second substrates in the liquid crystal display element) is, for example, a flexible sheet (substrate). The flexible sheet (substrate) may be a film formed of a polymer. Examples of useful materials for the polymer sheet (substrate) are polyether sulfone (PES), polycarbonate (PC), polyethylene terephthalate (PET), polyarylate (PA), polyether ether ketone (PEEK), cyclic amorphous polyolefin, etc. The thickness of the polymer sheet (substrate) is, for example, about 50 μm to about 1000 μm. The use of a thin sheet (substrate) reduces the thickness of the liquid crystal display element as a whole, and decreases the weight thereof.

Electrodes may be formed on respective sheets (substrates) to display images by changing an orientation of liquid crystal molecules. For simple matrix drive of the liquid crystal display element, each of the substrates may be provided with a plurality of band-like electrodes. For active matrix drive of liquid crystal display element, TFT, MIM or like active element as well as the electrode may be formed on the substrate. The liquid crystal display element produced by the first type producing method may be any of elements capable of achieving light-transmitting type display or light reflection-type display.

If required, an orientation film, an insulating film, a gas barrier film and the like may be formed on the sheet (substrate).

The liquid crystal (liquid crystal composition) to be arranged between the sheets (substrates) may be a liquid crystal composition containing a liquid crystal exhibiting a cholesteric phase (e.g. a liquid crystal exhibiting the cholesteric phase at room temperature). The liquid crystal exhibiting the cholesteric phase selectively reflects the light of wavelength corresponding to a helical pitch of the liquid crystal. Accordingly the liquid crystal display element in which the liquid crystal exhibiting the cholesteric phase is arranged between the substrates can be used as the liquid crystal display element of the reflection type. The liquid crystal exhibiting the cholesteric phase may further contain a pigment for adjustment of a display color.

The liquid crystal exhibiting the cholesteric phase may be, for example, a cholesteric liquid crystal exhibiting the cholesteric phase by itself, or a chiral nematic liquid crystal containing a nematic liquid crystal and a chiral material added to the nematic liquid crystal. The chiral nematic liquid crystal has an advantage that the helical pitch can be adjusted by the amount of the chiral material, and therefore the selective reflection wavelength can be easily adjusted.

What is described on the preliminary step is also true with respect to the second type producing method to be stated later.

(b) Adhesive Material-Supplying Step

In the adhesive material-supplying step, the adhesive material is supplied in a predetermined configuration onto at least one of the first and second sheets. The adhesive material may be supplied onto the sheet(s) before fixing the sheets.

At least a part of the adhesive material to be supplied onto the sheet(s) in the adhesive material-supplying step is used for forming the seal walls for the plurality of the liquid crystal display elements to be produced. That is, at least a part of the adhesive material to be supplied onto the sheet(s) is an adhesive material for the seal walls.

In the adhesive material-supplying step, the adhesive material is supplied in the predetermined configuration onto the sheet(s) so as to satisfy a condition to be described later.

For satisfying the condition, the adhesive material to be supplied onto the sheet(s) may include, in addition to the adhesive material for forming the seal walls, an adhesive material for forming a structure which does not compose the seal wall, or in other words, an adhesive material for forming a structure which is not to be the seal wall, e.g., an adhesive material for forming a dummy wall. That is, at least one dummy wall may be formed in addition to the seal walls onto the sheet(s) using the adhesive material in the adhesive material-supplying step. The dummy wall is to be adhered to both of the first and second sheets in the fixing step, however, does not function as the seal wall which is provided for preventing the leakage of the liquid crystal from the space between the sheets after fixing them together. The sheet portion onto which the adhesive material for the dummy wall is supplied may be finally removed in some cases. The total of the adhesive material supplied onto the sheet may be used for forming the seal walls in some cases.

The adhesive material for the seal walls may be selected, for example, from materials conventionally known as sealing materials. The adhesive material for the seal wall may be the same kind as or a different kind from that of the adhesive material for the dummy wall. If these two materials are the same kind, they can be supplied efficiently onto the sheet.

The adhesive material may be, for example, a UV-curing resin or a thermosetting resin.

The adhesive material may be supplied onto the sheet, for example, by a dispenser method, ink-jet method or the like. The adhesive material may be supplied onto the sheet by a printing method using a screen plate, metal mask or the like. Or the adhesive material may be supplied onto the sheet by a transfer method in which the adhesive material is firstly supplied onto a flat plate or a roller and then transferred to the sheet.

In the adhesive material-supplying step, the adhesive material is supplied onto the sheet(s) such that at least two seal walls in total are formed on the sheet(s) using the adhesive material. That is, at least two seal walls in total are formed onto the sheet(s) using the adhesive material in the adhesive material-supplying step. The plurality of seal walls are formed from the adhesive material onto the sheet such that a region surrounded by the seal wall (a region in which the liquid crystal is disposed) would not overlap to another.

For example, the plurality of the seal walls may be formed in such an arrangement pattern that at least two seal walls are neighboring to each other in a pressure progression direction which is described in the fixing step. The plurality of the seal walls may be formed in such an arrangement pattern that at least two seal walls are neighboring to each other in a direction perpendicular to the pressure progression direction. Or the plurality of the seal walls may be formed in such an arrangement pattern that position of at least two seal walls are shifted to each other in both of the pressure progression direction and the direction perpendicular thereto. Anyway, the first type producing method is especially useful when the positions of at least two seal walls are shifted in the pressure progression direction, and typically when at least two seal walls are formed to be arranged in line in the pressure progression direction.

(c) Spacer-Supplying Step

The spacer-supplying step may be performed to arrange spacer(s) between the two substrates of the liquid crystal display element, if necessary.

In the spacer-supplying step, at least one spacer is supplied onto at least one of the first and second sheets (substrates).

The spacer is to be arranged between the first and second substrates (sheets) after fixing the first and second sheets, and serve to control the gap between the first and second substrates, or in other words to control the thickness of the liquid crystal.

The spacer may be either fixable one which can be fixed to the substrate or non-fixable one which can not be fixed thereto.

The non-fixable spacer may be, for example, a particle made of hard material which do not deform when heated or pressed. The non-fixable spacer may be a fine particle of glass fiber, a spherical silicic acid glass particle, an inorganic material particle such as an alumina particle, or an spherical particle made of organic synthetic material such as divinylbenzene crosslinked polymer, polystyrene crosslinked polymers and like.

The fixable spacer may be, for example, non-fixable spacer coated with a hot-melt adhesive, thermosetting resins, UV-curing resins or the like.

The spacers may be supplied onto the sheet (substrate) by dispersing onto the sheet by the conventional method such as dry method, wet method or the like. The spacers may be dispersed typically before the fixing step. The spacers may be dispersed onto, for example, an area surrounded by the seal wall after forming the seal walls on the sheet using the adhesive material. The spacers can be dispersed only within the area surrounded by the seal wall by using a mask.

The spacers may be supplied onto the sheet (substrate) simultaneously with the supply of the liquid crystal by being dispersed in the liquid crystal to be supplied onto the sheet in the liquid crystal-supplying step.

What is described on the spacer-supplying step is also true with respect to the second type producing method to be stated later.

(d) Resin Structure-Forming Step

The resin structure-forming step may be performed for arranging the resin structure(s) between the substrates of the liquid crystal display element, if necessary.

In the resin structure-forming step, at least one resin structure is formed onto at least one of the first and second sheets. This step is performed typically before fixing the sheets.

The resin structure may be formed on at least one of the two sheets before superimposing the two sheets. The resin structure can be formed, for example, by a printing method in which a paste of resin-containing material (e.g. a resin dissolved in a solvent) is supplied onto the sheet through a screen plate, a metal mask or the like using a squeegee. The resin structure can be formed by a dispenser method or ink-jet method in which a resin is supplied from a nozzle onto the sheet. The resin structure can be formed by a transfer method in which a resin is supplied onto a flat plate or a roller and then is transferred to the sheet.

The resin structure may be fixed to both of the two sheets after fixing the two sheets. The resin structure can increase the strength of the entire liquid crystal display element and can maintain the gap between the sheets at a predetermined distance. The gap between the sheets (substrates) can be kept from widening by the resin structure fixed to both of the sheets (substrates).

Material for the resin structure may be a material which can be softened by heating and can be solidified by cooling. Preferable material for the resin structure is an organic material which does not chemical react with the liquid crystal material to be used, and provide a suitable flexibility to the resin structure. Material for the resin structure may be, for example, thermoplastic polymer material such as polyvinyl chloride resin, polyvinylidene chloride resin, polyvinyl acetate resin, polymethacrylic acid ester resin, polyacrylic acid ester resin, polystyrene resin, polyamide resin, polyethylene resin, polypropylene resin, fluorine-containing resin, polyurethane resin, polyacrylonitrile resin, polyvinyl ether resin, polyvinyl ketone resin, polyether resin, polyvinyl pyrrolidone resin, saturated polyester resin, polycarbonate resin, chlorinated polyether resin. The resin structure may be formed using a material containing one or more of these resins.

The resin structure may have a dot-like form such as a columnar form having a circular, square or elliptic section.

What is described on the resin structure-forming step is also true with respect to the second type producing method to be stated later.

(e) Liquid Crystal-Supplying Step

The liquid crystal-supplying step may be performed if employing the supply of the liquid crystal onto the sheet before and/or during fixing the sheets.

The liquid crystal can be arranged between the substrates by performing the liquid crystal-supplying step or the liquid crystal-filling step to be described later in detail.

In the liquid crystal-supplying step, the liquid crystal for at least one of the liquid crystal display elements is supplied onto at least one of the first and second sheets.

The liquid crystal may be supplied onto the sheet, for example, in a dropwise manner. The liquid crystal may be supplied onto the entire or part of the sheet. For example, after the plurality of the seal walls are formed on the sheet using the adhesive material, the liquid crystal may be supplied to each of regions surrounded by the respective seal walls. The supply of liquid crystal in this way may be done, e.g. before fixing the sheets.

The liquid crystal may be supplied to a space between the sheets, before and/or during fixing the first and second sheets from one end portion of the sheets to the other end portion thereof in the sheet-fixing step. When the liquid crystal is supplied during fixing the sheets, the liquid crystal need not to be continuously supplied during the fixing the sheets, and may be supplied for at least a part of a fixing period. For example, the liquid crystal may be supplied from the beginning of fixing operation to an intermediate point thereof (e.g. intermediately before completion thereof).

What is described on the liquid crystal-supplying step is also true with respect to the second type producing method to be stated later.

(f) Fixing Step (Sheet-Fixing Step)

In the fixing step, the first and second sheets are fixed or adhered together with the adhesive material (with the seal walls made of the adhesive material) therebetween. The first and second sheets are fixed by adhering the adhesive material to each of the two sheets.

The plurality of seal walls made of the adhesive material are interposed between the first and second sheets by fixing the first and second sheets.

When the liquid crystal is supplied onto the sheet before fixing the two sheets, the first and second sheets are fixed with the adhesive material and liquid crystal therebetween in the fixing step. In this case, the first and second sheets are fixed together, and thereby the adhesive material and liquid crystal are arranged between the sheets.

In the fixing step, the first and second sheets are fixed together while applying a pressure to the sheets from one end portion of the sheets to the other end portion thereof. A direction in which the application of the pressure progresses when the pressure is applied to the sheets from one to the other end portion of the sheets, in other words, a direction in which the portion of the sheets receiving the pressure moves is referred to as “pressure progression direction”. The pressure may be applied to at least an area of the sheets from the upstream end to the downstream end, in the pressure progression direction, of the plural seal walls made of the adhesive material on the sheet(s). Of course, the pressure may be applied from a position further upstream of the upstream end of the seal walls, and/or may be applied to a position further downstream of the downstream end thereof.

The first and second sheets may be fixed together while applying a heat in addition to the pressure. For example, the first and second sheets may be fixed together while applying the pressure and heat to the sheets from one end portion of the sheets to the other end portion thereof.

In the fixing step, if at least one of the first and second sheets is flexible, these sheets may be fixed together while the flexible sheet is bending. More specifically, the first and second sheets may be fixed together from one to the other end portion of the sheets in such a manner that, e.g., one of the sheet is always kept flat, the flexible sheet is fixed to the other sheet in the flat form from one end to the other end portion thereof while bending or curving the flexible sheet during the operation of fixing, and the flexible sheet become finally flat by decreasing the bending angle thereof in the operation of fixing.

In the case where the liquid crystal is supplied onto the sheet, e.g., before the fixing step, the first and second sheets are preferably overlapping to each other from one end portion of the sheets to the other end portion thereof in order to assure an escape of air bubbles, instead of overlapping the two sheets in their entirety at one time. By bending the flexible sheet, the first and second sheets can be overlapping to each other in this way from one end portion of the sheets to the other end portion thereof. In the case where the liquid crystal is supplied onto the sheet, e.g., before the fixing step, the first and second sheets can be fixed together while discharging the air bubbles from the liquid crystal by applying the pressure successively to the portions of the first and second sheets being superimposed. This suppresses remaining of air bubbles in the liquid crystal, resulting in production of the liquid crystal display element capable of achieving good image display. If only one of the first and second sheets is flexible, the flexible sheet may be fixed to the other sheet while the flexible sheet is bending. If both of the first and second sheets are flexible, these sheets may be fixed together while at least one of the sheets is bending.

When at least one of the first and second sheets is flexible, the sheets may be fixed together while pressing the sheets, for example, in the following manner described in the items (f1) or (f2). In the following item (f1) and (f2), it is assumed that the second sheet is flexible, and the first sheet may be either flexible or inflexible.

(f1) For example, firstly, the first sheet is supported in a flat state by a support member. Next, the flexible second sheet is bent so as that only one end portion of the flexible second sheet is superimposed over the first sheet supported by the support member with the adhesive material therebetween. Thereafter one or more pressing members are moved relatively to the first sheet supported by the support member, and thereby the flexible second sheet is pressed toward the first sheet from one end portion of the sheets to the other end portion thereof, whereby the first and second sheets are fixed together.

The pressing member may be, for example, a pressing roller. A plurality of pressing members may be used.

In the operation of fixing the sheets together, the pressing member is moved relatively to the support member. Accordingly, the pressing member or the support member may be moved, or both may be moved.

When the first and second sheets are fixed together in the above manner, the liquid crystal may be supplied onto at least one of the sheets, e.g. before fixing the sheets as described above.

If employing application of the heat and pressure to the sheets in the operation of fixing, a heating member may be moved relatively to the first sheet supported by the support member, so that the sheets are fixed together from one end portion of the sheets to the other end portion thereof while applying the heat from the second sheet side.

The heating member may be provided with a heater at its surface or in its interior. For example, the heating member may be a heating roller internally provided with a heater. A plurality of the heating members may be employed. The heating member may be in contact or out of contact with the second sheet in the operation of fixing. If the heating member is in contact with the second sheet in the operation of fixing, a higher heating efficiency can be achieved. The heating member may serve also as a pressing member. That is, the heat and pressure may be applied to the sheets by a pressing-heating member (e.g. pressing-heating roller). When the sheets are fixed with a plurality of the pressing members as described above, at least one of the pressing members may be used as the pressing-heating member capable of heating as well as pressing the sheets.

If employing the application of the heat in the operation of fixing, the heat may be applied to the sheets from the side of the support member supporting the first sheet. In this case, a heater for heating the support member may be provided. Of course, the sheets may be fixed while applying the heat from both the first sheet side and the second sheet side.

(f2) The first and second sheets may be fixed together by passing through a pair of pressing members, i.e., first and second pressing members opposed to each other, so that the sheets are superimposed over each other to be fixed to each other with the adhesive material therebetween from one end portion of the sheets to the other end portion thereof.

The pressing member may be, for example, a pressing roller, a pressing belt or the like.

For example, the first and second sheets may be passed through a nip portion between the first and second pressing members so that the sheets are overlapping to each other to be fixed from one to the other end portion of the sheets. For passing through the sheets between the pressing members, the pressing member side may be moved to the sheet side, or the sheet side may be moved to the pressing member side, or both of the sheet side and the pressing member side may be moved.

The sheets may be fixed while applying the pressure by plural pairs of the pressing members.

If employing application of the heat and pressure in the operation of fixing, at least one of the paired pressing members may serve also as a heating member. And the first and second sheets may be fixed from one end portion of the sheets to the other end portion thereof while applying the pressure and heat by the pressing member (pressing-heating member) serving also as the heating member. If pressing the sheets with a plurality pairs of the pressing members as described above, at least one of at least one pair among the plural pairs of the pressing members may be also serving as the heating member.

If a pair of the pressing rollers are used as a pair of the pressing members, a direction of each of the rotation axes of the pressing members may be set to the horizontal direction, and the first and second sheets may be fixed together by passing these sheets through these pressing rollers from an upper side to a lower side in the vertical direction.

When the first and second sheets are fixed together by being passed between a pair of pressing members as described above, the liquid crystal may be supplied onto the sheets during the operation of fixing the sheets from one end portion of the sheets to the other end portion thereof.

What is described on the manner of fixing the sheets is also true with respect to the second type producing method to be stated later.

(g) After the sheets are fixed together, the plurality of seal walls each made of the adhesive material are arranged between the sheets.

In the case where the liquid crystal is supplied onto the sheet before and/or during fixing the sheets, the liquid crystal is already filled in each of the space surrounded by the sheets and the respective seal walls after fixing the sheets. In this case, by cutting the sheets along the predetermined cut line(s) to divide into individual liquid crystal display elements after fixing the sheets, and thereby the plurality of the liquid crystal display elements, in each of which the seal wall and the liquid crystal are arranged between the substrates, are obtained.

In the case where the liquid crystal is supplied onto the sheet neither before nor during fixing the sheets, a plurality of empty-liquid crystal display elements in the continuous form are obtained after the fixing step. Each of the empty-liquid crystal display elements does not have the liquid crystal in the space surrounded by the sheets (substrates) and seal wall. In this case, the sheets may be cut along the predetermined cut line(s) to divide into individual empty-liquid crystal display elements, and thereafter the following liquid crystal filling step may be conducted with respect to each of the empty-liquid crystal display elements, so that the plurality of the liquid crystal display elements are obtained.

(h) Liquid Crystal-Filling Step

In the case where the liquid crystal is supplied onto the sheet neither before nor during fixing the sheets, the liquid crystal-filling step may be performed after the sheet-fixing step. The liquid crystal-filling step may be performed before or after cutting to divide the sheets.

In the liquid crystal-filling step, the liquid crystal is filled into the space surrounded by the seal wall and first and second substrates. In order to fill the liquid crystal into that space, an inlet port for entry of the liquid crystal may be formed in each seal wall made of the adhesive material in the adhesive material-supplying step. The liquid crystal may be filled into that space, for example, by vacuum filling method. After completion of filling of the liquid crystal, the inlet port for entry of the liquid crystal may be closed with a sealing material.

What is described on the liquid crystal-filling step is also true with respect to the second type producing method to be stated later.

### §1.3.

In the first type producing method, the adhesive material is supplied onto the sheet(s) so as to satisfy the following condition in the adhesive material-supplying step.

The adhesive material is supplied onto at least one of the sheets in the adhesive material-supplying step so as that the adhesive material continuously adheres to the first and second sheets in the pressure progression direction when these sheets are pressed from one end portion of the sheets to the other end portion thereof in the sheet-fixing step.

If the adhesive material were discontinuously adhered to the sheets in the pressure progression direction in the sheet-fixing step, that is, if the adhesive material were intermittently adhered to the sheets in the pressure progression direction, the following problem would arise in some cases. The first and second sheets would be fixed together such that one or more of region of the sheets are pressed with the adhesive material therebetween, and one or more regions of the sheets are pressed without the adhesive material therebetween, if the adhesive material were intermittently adhered to the sheets during the operation of fixing of the sheets while applying the pressure to the sheets from one to the other end portion of the sheets in the pressure progression direction. This would result in an unintended partial bending or curving of the sheet at the region where the sheets are pressed without the adhesive material therebetween, so that the relative positional relationship between the first and second sheets (positional relationship between the first and second substrates of the liquid crystal display element) would be shifted with respect to the predetermined positional relationship therebetween. If the first and second sheets were pressed to be fixed together such that the region of the sheets with the adhesive material therebetween is pressed after the region of the sheets without the adhesive material therebetween is pressed, the first and second sheets would be fixed together while the sheet would be kept partially bent, so that the first and second sheets would be fixed together with the shifted positional relationship. Further, the sheets (substrates) would remain having partial bending region, which would give stress to the adhesive material (seal wall made of the adhesive material) for fixing the sheets (substrates), causing separation of the seal wall from the substrate (sheet).

In contrast to the above, according to the first type producing method, the adhesive material can fix the first and second sheets continuously and unintermittently in the pressure progression direction, so that the remaining of partial bending of the sheet can be suppressed, and also the shift of the positional relationship between the sheets can be suppressed, which make it possible to produce the liquid crystal display elements capable of performing good display.

### §1.4.

Next, additional description is given to the adhesive material-supplying step in the first type producing method.

The adhesive material need not be supplied onto the sheets from one end of the sheet to the other end thereof in the pressure progression direction in the adhesive material-supplying step. In the adhesive material-supplying step, the adhesive material is supplied onto at least the sheet portion to be pressed in the sheet-fixing step. In the sheet-fixing step, as stated above, the pressure is applied to the sheets from the upstream end to the downstream end, in the pressure progression direction, of the plurality of seal walls formed on the sheet(s) using the adhesive material.

In the adhesive material-supplying step, the adhesive material is supplied in the predetermined configuration onto at least one of the first and second sheets as described above to form the plurality of seal walls. Accordingly, the adhesive material may be supplied in the predetermined configuration onto each of the first and second sheets. In the case where the adhesive material is supplied onto each of the first and second sheets, it is enough that the sheets are fixed together so as to satisfy the foregoing condition by a combination of the adhesive materials supplied onto the first and second sheets, even if only the adhesive material supplied to the single sheet cannot to fix the sheets so as to satisfy the foregoing condition.

The adhesive material may be supplied onto each of the first and second sheets as described above. However, when the adhesive material is supplied onto only one of the sheets, the supply of adhesive material can be done with less time and others than when the adhesive material is supplied onto each of the sheets, resulting in more efficient and inexpensive production of liquid crystal display elements.

In the case where the adhesive material is supplied onto only one of the sheets, the adhesive material may be supplied onto the sheet in such a configuration that there exists the adhesive material somewhere in a direction perpendicular to the pressure progression direction, at each position from the upstream end to the downstream end, in the pressure progression direction, of the plurality of seal walls to be formed on the sheet. When the adhesive material is supplied in the above configuration onto the sheet, the adhesive material can continuously adhere to the sheets from the upstream end to the downstream end, in the pressure progression direction, of the seal walls in the sheet-fixing step.

The sheets may be fixed so as to satisfy the foregoing condition in consequence of a deformation of the adhesive material caused by the pressure applied thereto via the sheets in the sheet-fixing step. In other words, the adhesive material may be supplied onto the sheet(s) in such a configuration that the adhesive material adheres to the sheets continuously in the pressure progression direction due to deformation of the adhesive material in the sheet-fixing step.

The sheets cannot be fixed together so as to satisfy the foregoing condition, for example, in the case where only the seal walls are formed onto the sheet(s) using the adhesive material, which depends on the arrangement pattern of the seal walls on the sheet(s). For satisfying the foregoing condition, at least one dummy wall, which does not function as the seal wall, may be formed onto the sheet(s) using the adhesive material in addition to the seal walls in the adhesive material-supplying step. The dummy wall may be formed on and/or inside an external frame formed of the plurality of seal walls on the sheet for, e.g., widening each the region surrounded by the respective seal walls formed on the sheet, or more specifically, for widening each of the display regions of the liquid crystal display elements. The dummy wall may be connected to the seal wall for forming or arranging the dummy wall on and/or inside the external frame formed of the plurality of seal walls on the sheet.

According to a specific arrangement pattern of the plural seal walls to be formed on the sheet, it is possible to fix the sheets so as to satisfy the foregoing condition without forming the dummy wall on the sheet, or in other words, by forming only seal walls on the sheet. For this, the plurality of seal walls may be formed such that, for example, each seal wall at least partly overlaps over at least one of other seal wall(s) in the pressure progression direction. Of course, the overlapping of seal walls in the pressure progression direction is done while shifting the positions of these seal walls in the direction perpendicular to the pressure progression direction not for overlapping of regions surrounded by the respective seal walls.

### §2. Second Type Producing Method

In the following description, a second type of liquid crystal display elements producing method is presented.

According to the second type producing method, similarly to the foregoing first type producing method, a plurality of liquid crystal display elements are produced.

Each of the liquid crystal display elements to be produced by the second type producing method is as follows.

Each of the liquid crystal display elements has a pair of substrates, i.e., first and second substrates. Each of the liquid crystal display elements further has a liquid crystal and a seal wall.

Each of the first and second substrates may be typically provided with at least one electrode for driving the liquid crystal display element to perform displaying. The first and/or second substrate may be provided with an orientation film, insulating film, gas barrier film and/or other film(s), if necessary.

The liquid crystal is arranged between the first and second substrates.

The seal wall is arranged between the first and second substrates, is adhered to the both of the first and second substrates. The seal wall may typically surround the liquid crystal arranged between the first and second substrates. The seal wall is provided for sealing the liquid crystal in a space between the first and second substrates, in other words, for preventing a leakage of the liquid crystal from the space between the first and second substrates.

The plurality of the liquid crystal display elements to be produced by the second type producing method may have same size and configuration, or may be different size and configuration.

The second type producing method includes an adhesive structure forming step and an adhering step (fixing step).

In the adhesive structure forming step, at least one adhesive structure, that is, one or more of adhesive structure(s) are formed onto at least one of following first and second sheets.

The first sheet, used in the adhesive structure forming step, includes a plurality of portions that are to be the first substrates for the plurality of the liquid crystal display elements to be produced by the second type producing method. That is, the first sheet has a size which is required for producing the plurality of the liquid crystal display elements by the second type producing method.

Likewise, the second sheet, used in the adhesive structure forming step, includes a plurality of portions that are to be the second substrates for the plurality of the liquid crystal display elements to be produced by the second type producing method. That is, the second sheet has a size which is required for producing the plurality of the liquid crystal display elements by the second type producing method.

The first and/or second sheet may be a sheet having a flexibility. The first and/or second sheet may be the polymer film. The first sheet may be provided with the first electrodes for the plurality of the liquid crystal elements to be produced by the second type producing method, in which case the first substrate of the liquid crystal display element would be provided with one or more of the first electrodes. Likewise, the second sheet may be provided with the second electrodes for the plurality of the liquid crystal elements to be produced by the second type producing method, in which case the second substrate of the liquid crystal display element would be provided with one or more of the second electrodes. The first and/or second sheet may be provided with the orientation film, insulating film, gas barrier film and/or other film(s), if necessary.

Onto at least one of the above first and second sheets, one or more of the adhesive structure(s) is/are formed in the adhesive structure forming step. In the case where two or more of the adhesive structures are to be formed, one or more among the total adhesive structures may be formed onto the first sheet, and the remaining adhesive structure(s) may be formed onto the second sheet.

In the adhesive structure forming step, the adhesive structure(s) is/are formed using at least one kind of adhesive material. In the case where two or more of the adhesive structures are to be formed, the kind of adhesive material of all the adhesive structures may be same, or different.

At least a portion of the adhesive structure(s), formed in the adhesive structure forming step, is to serve as the seal walls for the plurality of the liquid crystal display elements to be produced by the second type producing method. That is, the adhesive structure(s) as the seal walls is/are formed with one or more kinds of the adhesive material(s) in the adhesive structure forming step for the plurality of the liquid crystal display elements to be produced by the second type producing method.

In addition to the seal walls, one or more of dummy wall(s), each of which does not function as the seal wall, may be formed with one or more kind(s) of the adhesive material(s) in the adhesive structure forming step. That is, at least a portion of the adhesive structure(s), formed in the adhesive structure forming step, may be to be the dummy wall(s). In other words, the adhesive structure(s) as the dummy wall(s) may be formed in addition to the adhesive structure(s) as the seal walls in the adhesive structure forming step. The kinds of adhesive material for the seal walls and dummy wall(s) may be same or different. The purpose, advantage and others for forming the dummy wall(s) are described later.

In any cases, at least the seal walls for the plurality of the liquid crystal display elements are formed in the adhesive structure forming step.

After the adhesive structure forming step, the adhering step is performed.

In the adhering step, the first and second sheets are adhered or fixed together with the adhesive structure(s) therebetween. The adhesive structure(s), to be located between the first and second sheets, may be hardened by an appropriate method, which depends on the kind of material of the adhesive structure(s), during and/or after the adhering step.

In the adhering step, the first and second sheets are adhered together while applying a pressure. The pressure is applied along a predetermined pressure progression direction. That is, the pressure is not applied to the whole area of the first and second sheets at the same time. For example, the pressure may be applied from one end portion of the first and second sheets to the other end portion along the pressure progression direction. The pressure may be continuously applied along the pressure progression direction.

In the second type producing method, the adhesive structure(s), formed in the adhesive structure forming step and located between the first and second sheets in the stage after performing the adhering step, occupies or occupy, at every position with respect to the pressure progression direction in a range from an upstream end thereof to a downstream end thereof, at least a part of a gap between the first and second sheets.

More specifically, in the stage after the adhering step, the adhering structure(s), located between the first and second sheets, occupies or occupy at least a part, in a perpendicular direction with respect to the pressure progression direction, of the gap between the first and second sheets at the every position in the above range along the pressure progression direction.

In other words, in the stage after the adhering step, there exists, somewhere in the perpendicular direction with respect to the pressure progression direction, between the first and second sheets at least one adhesive structure (at least one portion of at least one adhesive structure) in every position in a range from one end position to the other end position of the adhesive structure(s) in the pressure progression direction (i.e., at the every position in the range from the upstream end to the downstream end of the adhesive structure(s) along the pressure progression direction). That is, there is no space of absence of the adhesive structure in the above range along the pressure progression direction.

In brief, in the stage after the adhering step, the adhesive structure(s), located between the first and second sheets, has no space of absence thereof in the pressure progression direction. In further other words, in the stage after the adhering step, the adhesive structure(s), located between the first and second sheets, is/are adhered to both of the first and second sheets continuously without the space of absence of the adhesive structure along the pressure progression direction.

At least one adhesive structure, located between the first and second sheets after adhering step, is required to exist merely somewhere in the perpendicular direction with respect to the pressure progression direction, in every position in the above range along the pressure progression direction. Accordingly, if two or more adhesive structures are located between the first and second sheets after adhering step, it is not required for the adhesive structures to continuously connect to each other.

For example, in the case where three adhesive structures, i.e., first, second and third adhesive structures are located between the first and second sheets after the adhering step, and the first and second adhesive structures are spaced apart in the pressure progression direction, there exists at least one of the first to third adhesive structures in every position in the above range along the pressure progression direction, if the third adhesive structure is arranged so as to fill the space between the first and second adhesive structures in the pressure progression direction, even if the third adhesive structure is shifted with respect to the first and second adhesive structures in the perpendicular direction with respect to the pressure progression direction.

Accordingly, after performing the adhering step, at least one of the adhesive structure(s) can be seen between the first and second sheets in every position in the above range along the pressure progression direction.

From another point of view, the adhesive structure(s) is/are formed onto at least one of the first and second sheets in an arrangement pattern which makes it possible for the adhesive structure(s) to occupy, at every position in the above range along the pressure progression direction, at least a part of the gap between the first and second sheets after performing the adhesive step.

The adhesive structure(s), formed in the adhesive structure forming step, is required to have no space of absence thereof in the pressure progression direction merely after the adhering step. Accordingly, before performing the adhering step, the adhesive structure(s) may have a space of absence thereof in the pressure progression direction, in which case the adhesive structure would be have no space of absence thereof in the pressure progression direction by, e.g., a deformation of at least one adhesive structure caused by the pressure to be applied in the adhering step. Of course, the adhesive structure(s) may have no space of absence in the pressure progression direction already in the stage before the adhering step.

In the second type producing method, similar to the foregoing first type producing method, an appropriate arrangement pattern of the seal walls (i.e., the adhesive structure(s) as the seal walls) can provide no absence of the adhesive structure in the above range along the pressure progression direction, even if only the seal walls are formed onto the first and/or second sheet, that is, even if the dummy wall (i.e., the adhesive structure as the dummy wall) is not formed onto the sheet.

The adhesive structure(s) may have no space of absence thereof in the above range along the pressure progression direction by a combination of the dummy wall(s) and the seal walls.

In the case where the adhesive structure(s) as the seal walls as well as the adhesive structure(s) as the dummy wall(s) are formed in the adhesive structure-forming step, the seal walls may be formed on one of the first and second sheets and the dummy wall(s) may be formed on the other sheet. The seal walls and dummy wall(s) may be connected to each other before the adhering step for producing the liquid crystal display elements having a large display region from the first and second sheets.

According to the second producing method, similarly to the first type producing method, since the adhesive structure(s) are formed as described above, the first and second sheets can be fixed while suppressing the unintended partial bending of the first and second sheets, and also suppressing the shift of positional relationship between the first and second sheets (shift of positional relationship between the first and second substrates in each of the liquid crystal display elements), so that the plurality of liquid crystal display elements capable of displaying good images can be produced.

### §2.1.

Further description is given below to the second type producing method.

The second type producing method may employ the same manner, procedure and step as described concerning the first type producing method, e.g., as follows.

(a) The liquid crystal may be supplied onto at least one of the first and second sheets, more specifically onto at least a portion of at least one of the sheets, before the adhering step. In this case, the first and second sheets may be fixed with the liquid crystal and the adhesive structure therebetween the sheets in the adhering step.

The liquid crystal may be filled into each the space surrounded by the respective seal walls after the adhering step. The liquid crystal may be filled into the space, for example, by vacuum filling method. The filling of liquid crystal may be performed before or after cutting the first and/or second sheet into individual sets of the liquid crystal display elements after the adhering step.

(b) The pressure may be applied in the adhering step, for example, using a pair of first and second pressing members opposed to each other. In this case, the pressure may be applied to the sheets successively in the pressure progression direction while, e.g., nipping these sheets by the pressing members.

One of the first and second pressing members may be rotatable or rotary form, and may have a cylindrical form or have an arcing surface, while the other pressing member may have, for example, a flat surface. Or the first and second pressing members may be a pair of rollers.

### §3.

Now, description is given below, with reference to the drawings, to a preferred embodiment of the method for producing a plurality of liquid crystal display elements.

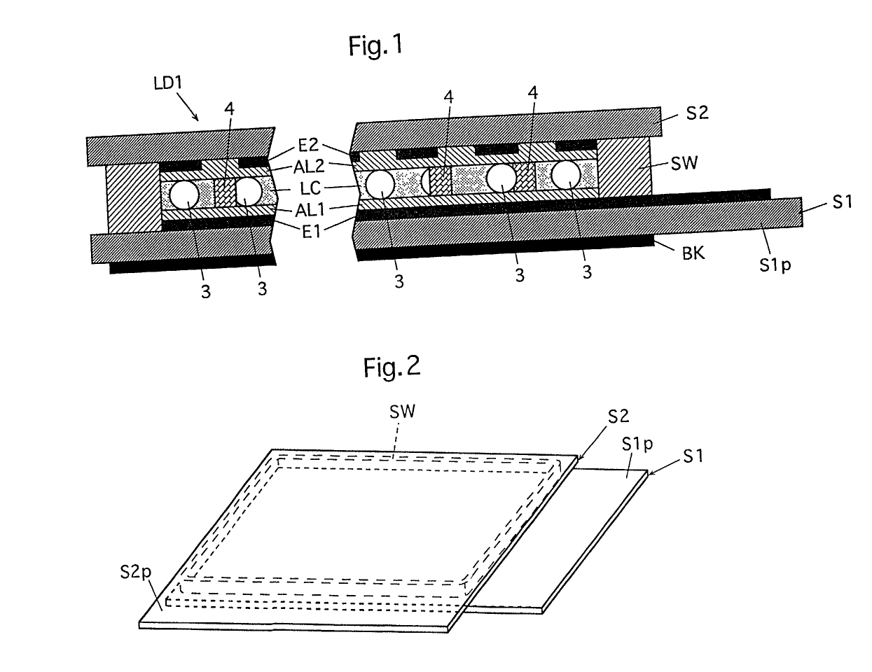

FIG. 1 is a section view schematically showing an example of the liquid crystal display element to be produced. FIG. 2 is a schematic perspective view of the liquid crystal display element of FIG. 1.

The liquid crystal display element LD1 of FIGS. 1 and 2 is a light reflection type liquid crystal display element.

The liquid crystal display element LD1 has a pair of substrates, i.e., first and second substrates S1 and S2. The liquid crystal display element LD1 has the following structure. A liquid crystal LC is arranged between the substrates S1 and S2. A seal wall SW is arranged between the substrates for preventing a leakage of the liquid crystal LC from a space between the substrates. The seal wall SW surrounds the liquid crystal LC between the substrates and adheres to both of substrates S1 and S2.

In this example, the substrates S1, S2 are films made of polycarbonate, and are both flexible.

Electrodes E1 and E2 are formed on the substrates S1 and S2, respectively for performing a simple matrix drive. The electrodes E1 and E2 are not shown in FIG. 2. The electrodes E1 and E2 are made of ITO in this example. The electrode E1 formed on the substrate S1 includes a plurality of band-like electrodes arranged in parallel with each other at a predetermined pitch. The electrode E2 formed on the substrate S2 includes, like the electrode E1, a plurality of band-like electrodes arranged in parallel with each other at a predetermined pitch, although not illustrated in the figure. The band-like electrodes of electrodes E1 and E2 are perpendicular to each other and have a matrix structure.

On the electrodes E1, E2 are formed orientation films AL1, AL2 (not shown in FIG. 2), respectively.

The liquid crystal LC is a chiral nematic liquid crystal including a nematic liquid crystal and a chiral material added thereto in this example. The chiral nematic liquid crystal exhibits a cholesteric phase at room temperature and selectively reflects the light of specified wavelength. The liquid crystal LC has a selective reflection wavelength in a green region in this example. Images displayed by the liquid crystal display element LD1 are observed from the upper side of the substrate S2 in FIG. 1. A black light absorbing layer BK is formed on the back side of the substrate S1 located a position remote from the observation side.

The liquid crystal display element LD1 further provided with a plurality of spacers 3 and a plurality of resin structures (adhesive columns) 4 between the substrates. The spacers 3 and resin structures 4 are not shown in FIG. 2. The spacers 3 are arranged between the substrates S1 and S2 to control the gap between the substrates S1 and S2, and more specifically to control the thickness of the liquid crystal LC. The resin structures 4 adhere to both of the substrates S1 and S2, and increase the adhesion strength between the substrates S1 and S2 as well as the strength of liquid crystal LD1 in its entirety.

In the liquid crystal display element LD1, the substrate S1 has a projected portion S1p which is not overlapped with the substrate S2. Similarly, the substrate S2 has a projected portion S2p which is not overlapped with the substrate S1. The electrodes E1, E2 are exposed at the projected portions S1p, S2p, without being hidden by the substrates S2, S1, respectively. In this example, a drive IC (not shown) is mounted on each of the projected portions.

The liquid crystal display element LD1 can display the desired images in the following way. A predetermined voltage is applied between the band-like electrode, corresponding to a drive target pixel, of electrode E1 and that of electrode E2 via the drive IC mounted on each of the substrates S1, S2. Thereby the orientation of the liquid crystal molecules at the drive target pixel is changed, so that the light-reflected state of the liquid crystal in each pixel is changed to display the intended images.

### §4.

Description is now given below on the method for producing a plurality of the above-described liquid crystal display elements LD1.

An outline of the producing method is as follows. A plurality of liquid crystal display elements (four elements in this example) are to be produced from a pair of sheets. For this, a plurality of seal walls are formed onto the sheet using an adhesive material (sealing material). Then the sheets are fixed, for example, with the liquid crystals and the seal walls for the plurality of the liquid crystal display elements therebetween. Thereafter the sheets are cut along predetermined cut lines to provide the plurality of the liquid crystal display elements in an independent form.

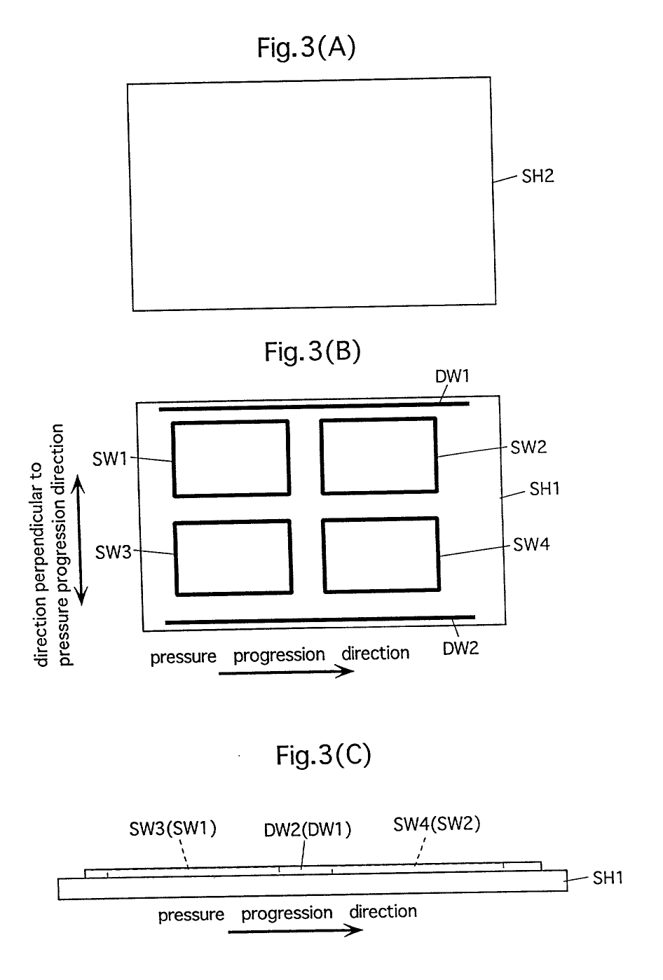

Now, detailed description is given below to each of the steps for producing the liquid crystal display elements LD1 with reference to the FIGS. 3(A), 3(B), 3(C) and 4 to 7.

(a) Preliminary Step (Preparation Step)

First, a pair of first and second sheets (substrates) SH1, SH2 are prepared. In this example, a polycarbonate films are used as the sheets. Each of the sheets SH1 and SH2 has a size required for producing four liquid crystal display elements LD1. The sheet SH1 has portions to be the first substrates S1 for the four liquid crystal display elements. Similarly, the sheet SH2 has portions to be the second substrates S2 for the four liquid crystal display elements.

(b) Functional Film-Forming Step

Onto a surface of the sheet SH1 thus prepared, an electrode E1 composed of the plurality of the band-like electrodes and the orientation film AL1 are formed in this order. For example, an electroconductive film (ITO film in this example) is uniformly formed on the sheet SH1, and thereafter the electrocoductive film is etched into the predetermined configuration to provide the plurality of the belt-like electrodes of the electrode E1 by utilizing a photolithography method and other. The orientation film AL1 can be formed, e.g. by a spin-coating method or the like.

Onto the other side of the sheet SH1, the black light absorbing layer BK is formed. The light absorbing layer BK can be formed, e.g. by applying a black paint material onto the sheet SH1.

The electrode E2 and orientation film AL2 are formed in this order onto the sheet SH2 in the same manner as done on the sheet SH1.

(c) Resin Structure-Forming Step

Next, the resin structures 4 are formed onto at least one of the sheets SH1 and SH2. In this example, the resin structures 4 are formed onto the sheet SH2 by a screen printing method. The resin structures 4 are formed, in this example, within regions of the sheet SH2, corresponding to regions surrounded with the seal walls to be formed on the sheet SH1 using adhesive material in the subsequent adhesive material-supplying step.

(d) Adhesive Material-Supplying Step (Adhesive Structure Forming Step)

Next, an adhesive material is supplied in a specified configuration onto at least one of the sheets SH1 and SH2. In this step, a plurality of seal walls (four seal walls in this example) are formed from at least a part of the adhesive material to be supplied onto the sheet(s). In other words, at least one adhesive structure is formed onto at least one of the sheets SH1 and SH2 with the adhesive material to form at least the plurality of the seal walls (four seal walls in this example).

In this example, the adhesive material is not supplied onto the sheet SH2 as shown in FIG. 3(A). The adhesive material is supplied in the predetermined configuration onto the sheet SH1 as shown in FIG. 3(B). The electrodes, orientation film and resin structures are not shown in FIGS. 3(A) and 3(B).

Four seal walls SW1 to SW4 are formed as the adhesive structures onto the sheet SH1 from the adhesive material. The seal walls SW1 to SW4 correspond to the seal wall SW shown in FIG. 1. Dummy walls DW1 and DW2 are also formed onto the sheet SH1 as the adhesive structures using the adhesive material. The liquid crystal is to be arranged within each of regions surrounded by the respective seal walls SW1 to SW4. None of dummy walls DW1 and DW2 function as the seal wall for preventing a leakage of the liquid crystal.

The seal walls and dummy walls are arranged on the sheet SH1 as follows.

The seal walls SW1 to SW4 are all in a square frame form. The seal walls SW1 and SW2 are arranged as spaced away from each other at a predetermined distance in a pressure progression direction as shown in FIG. 3(B). The pressure progression direction is a direction in which a pressure is applied to the sheets SH1 and SH2 from one end portion of these sheets to the other end portion thereof in the sheet-fixing step to be described later. The seal walls SW3 and SW4 are arranged as spaced away from each other at a predetermined distance in the pressure progression direction. The seal walls SW1 and SW3 are adjacent to each other in a direction perpendicular to the pressure progression direction. The seal walls SW2 and SW4 are also neighboring to each other in the direction perpendicular to the pressure progression direction.

The dummy walls DW1 and DW2 are both linear and extend in the pressure progression direction.

When the seal walls and dummy walls made of the adhesive material on the sheet SH1 are viewed in a direction perpendicular to the pressure progression direction and parallel with the plane of the sheet SH1, the dummy walls DW1 and DW2 fill up a space between the seal walls SW1 and SW2 in the pressure progression direction as well as a space between the seal walls SW3 and SW4 in the pressure progression direction. From another viewpoint, there exist at least one seal wall and/or at least one dummy wall made of the adhesive material somewhere in the direction perpendicular to the pressure progression direction, at every position in a range from an upstream end to a downstream end, in the pressure progression direction, of the seal walls on the sheet SH1. The upstream end, in the pressure progression direction, of the seal walls on the sheet SH1 is the left end of the seal walls SW1 and SW3 in FIG. 3(B). The downstream end, in the pressure progression direction, of the seal walls on the sheet SH1 is the right end of the seal walls SW2 and SW4 in FIG. 3(B).

In this example, the adhesive material is supplied in the above-mentioned predetermined configuration and arrangement pattern by a screen printing method to form the seal walls SW1 to SW4 as well as the dummy walls DW1 and DW2. In this example, the seal walls and dummy walls are formed from the same kind of adhesive material at one time by the screen printing method. The seal walls and the dummy walls may be formed with different kinds of adhesive materials.

(e) Spacer-Dispersing Step

Next, the spacers 3 are dispersed on each region surrounded by the respective seal walls SW1 to SW4 on the sheet SH1 at a predetermined density. The spacers 3 are dispersed on the sheet SH1 through a mask having openings corresponding to each region surrounded by the respective seal walls SW1 to SW4, whereby the spacers 3 can be dispersed only on the above-specified region on the sheet SH1.

(f) Liquid Crystal-Supplying Step (Liquid Crystal-Arranging Step)

Next, the liquid crystal LC for the plurality of the liquid crystal display elements are supplied onto at least one of the sheets SH1 and SH2.

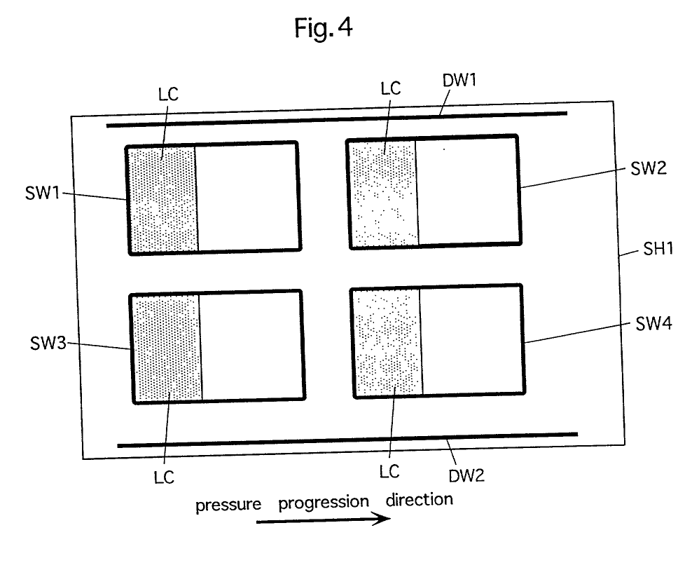

In this example, the liquid crystals are supplied onto each region surrounded by the respective seal walls SW1 to SW4 on the sheet SH1. A predetermined amount of the liquid crystal LC is supplied, as shown in FIG. 4, at an upstream region in the pressure progression direction within each region surrounded by the respective seal walls SW1 to SW4. The liquid crystal is supplied to be placed at each above region on the sheet SH1 from a dispenser (not shown). The liquid crystal is supplied at each above region on the sheet SH1 in an amount corresponding to the area of each region surrounded by the respective seal walls and a predetermined gap to be made between the substrates (sheets).

(g) Substrate-Fixing Step (Adhering Step)

Next, the sheets SH1 and SH2 are fixed together with the liquid crystals LC as well as the seal walls and dummy walls made of the adhesive material therebetween, while applying a pressure from one end portion of the sheets to the other end portion thereof in the pressure progression direction.

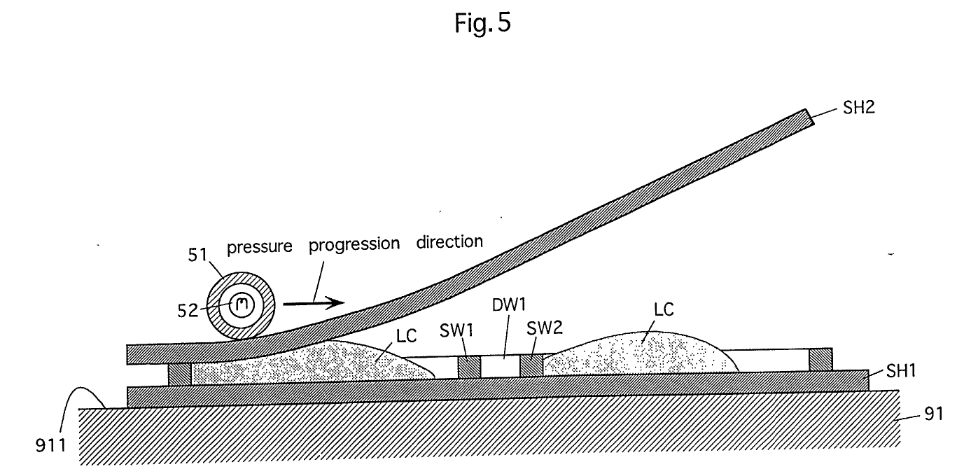

In this example, the sheets SH1 and SH2 are fixed together in the following manner. Referring to FIG. 5, the fixing step is described below. The spacers 3 and resin structures 4 are not shown in FIG. 5.

First, the sheet SH1 having the seal walls and the dummy walls formed thereon is placed on a flat surface 911 of a table 91. The table 91 has numerous vents (not shown) for air-suction. The sheet SH1 is sucked toward the flat surface 911 of the table 91 by air-suction through the vents. Thereby the sheet SH1 is unmovably held in a predetermined position on the flat surface 911.

Then, one end portion of the sheet SH2 is superimposed on one end portion of the sheet SH1 with the seal walls and dummy walls interposed therebetween. The sheet SH2 is positioned with respect to the sheet SH1 in a predetermined positional relationship, and then the sheets SH1 and SH2 are superimposed on each other as above.

Thereafter a roller 51 internally provided with a heater 52 is moved along the table 91, whereby the sheets SH1 and SH2 are pressed and heated from one end portion of the sheets to the other end portion thereof to fix them with the seal walls and liquid crystal LC therebetween. The resin structures and seal walls made of an adhesive material adhere to both sheets SH1 and SH2 to thereby adhere the sheets together.

At that time, the liquid crystal LC is filled into each region surrounded with respective seal walls SW1 to SW4 between the sheets (substrates) while the liquid crystal is spread with the sheet SH2. Thereby the liquid crystal LC can be arranged between the sheets while forcing out the air bubbles.

(h) Cutting Step

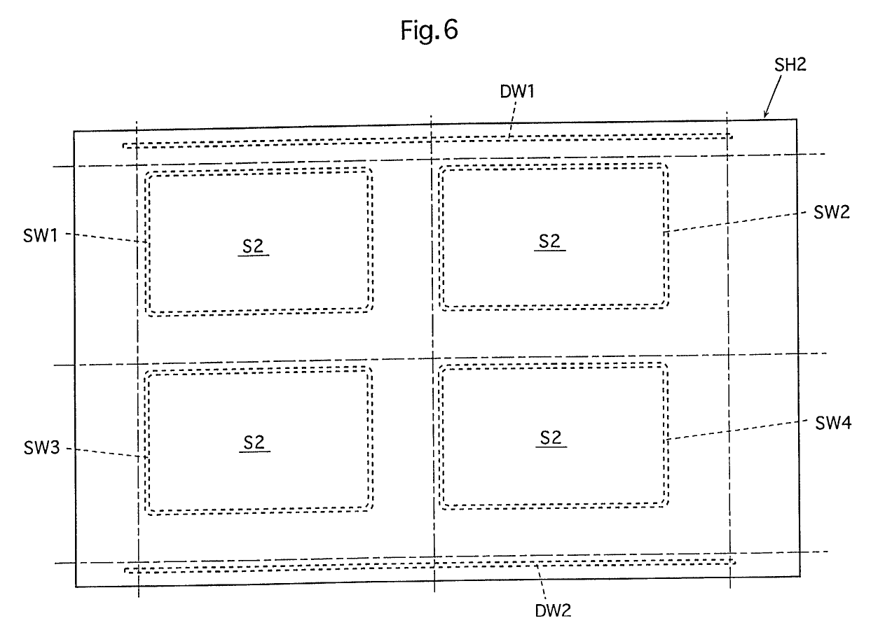

After fixing the sheets SH1 and SH2 in this way, the sheets are cut along cut lines shown with an alternate long and short dash line in FIG. 6, giving four liquid crystal display elements. The dummy walls DW1, DW2 are removed by the cutting procedure from the substrate of the liquid crystal display element.

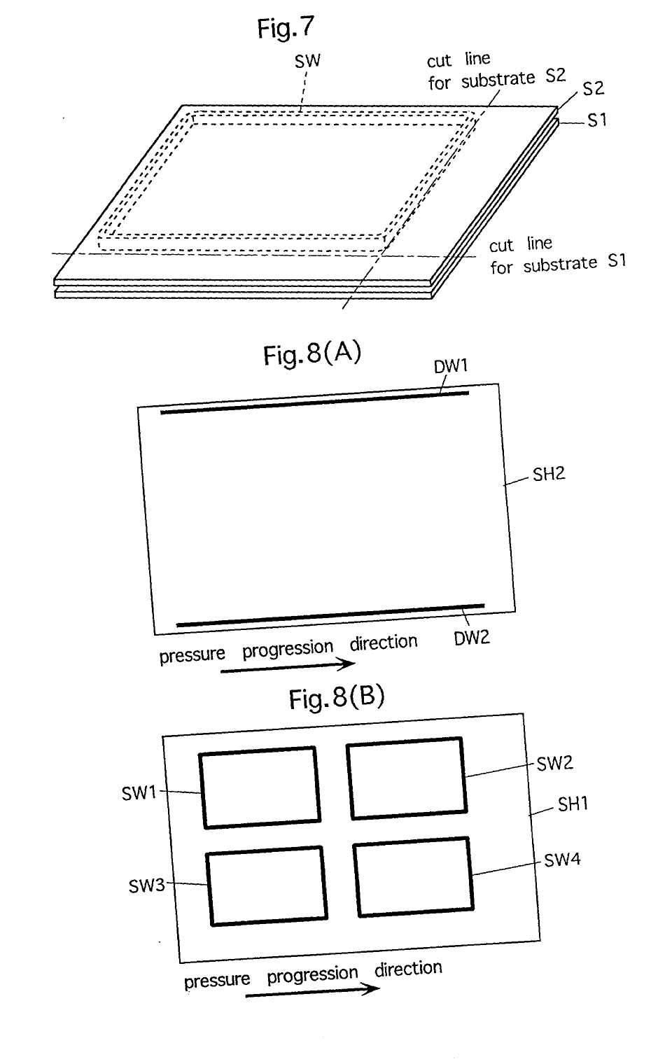

Then the substrates S1 and S2 of each of the liquid crystal display elements are further cut along cut lines shown with an alternate long and short dash line in FIG. 7 to expose the electrodes on the respective substrates S1 and S2.

Half-cut may be effected to the sheets SH1 and SH2 (substrates S1 and S2) along the cut lines to facilitate the cutting of the sheets (substrates).

In this way, four liquid crystal display elements LD1 shown in FIG. 1 and 2 are completed.

The above-mentioned method for producing liquid crystal display elements has the following advantages.

Since the adhesive material is supplied in the specified configuration onto the sheet SH1 as shown in FIG. 3(B) to form the seal walls SW1 to SW4 as well as the dummy walls DW1 and DW2 in the adhesive material-supplying step, the adhesive material can continuously adhere to the sheets SH1 and SH2 in the pressure progression direction when the sheets are pressed from one end portion of the sheets to the other end portion thereof in the sheet-fixing step. Therefore the adhesive structures formed in the adhesive structure-forming step (adhesive material-supplying step), i.e., the seal walls SW1 to SW4 as well as the dummy walls DW1 and DW2 in this example occupy at least a part of the gap between the sheets SH1 and SH2 at every position in the range from the upstream to downstream end of the seal walls SW1 to SW4 after the fixing step (adhering step).

If only the seal walls SW1 to SW4 were formed on the sheet SH1 in the arrangement of FIG. 3(B), and if the dummy walls DW1 and DW2 were not formed on the sheet SH1, there would not exist the adhesive material in a region between the seal walls SW1 and SW2 (a region between the seal walls SW3 and SW4) in the pressure progression direction. This would result in that the sheets SH1 and SH2 would be fixed together without the adhesive material (adhesive structure) therebetween in the region between the seal walls SW1 and SW2. In other words, the adhesive material would not continuously adhere to the sheets SH1 and SH2 in the pressure progression direction in the sheet-fixing step. If the adhesive material were intermittently adhered to the sheets SH1 and SH2, the following problem would arise. Since the sheets would be pressed without the adhesive material interposed therebetween in the region between the seal walls SW1 and SW2, the sheets would be partially bent or loosened in this region. Then, with the progress of application of pressure, the adhesive material forming the seal walls SW2 and SW4 would adhere to the sheets SH1, SH2 so that the sheets would be fixed as partial bent. In this event, the positional relationship between the sheets SH1 and SH2 would be shifted with respect to the predetermined positional relationship. If the sheets were fixed together with numerous seal walls which are arranged in row in the pressure progression direction with a space between each neighboring seal walls, the degree of shift of positional relationship between the sheets SH1 and SH2 would be increased as the sheet-fixing operation proceeds toward the downstream side in the pressure progression direction. As the degree of shift is increased, the area in which images can be displayed would be exceedingly shifted, thereby posing a problem when the liquid crystal display element is incorporated into a display device.

In contrast to the above, according to the foregoing method, the adhesive material forming the seal walls SW1 to SW4 as well as the dummy walls DW1 and DW2 adheres to the sheets SH1 and SH2 continuously in the pressure progression direction as described above, so that the foregoing problem can be overcome. Further, this suppresses the shift of positional relationship between the sheets and the partial bending of the sheets after fixing the sheets, whereby the liquid crystal display elements can be produced while the shift of positional relationship between the sheets and the partial bending of the sheets are suppressed.

### §5.

To be short, in order to prevent shift of positional relationship between the sheets in sheet-fixing step, the adhesive material is supplied in the predetermined configuration onto at least one of the sheets in the adhesive material-supplying step so as that the adhesive material will adhere to the sheets continuously in the pressure progression direction when the sheets are pressed from one end portion of the sheets to the other end portion thereof in the sheet-fixing step.

Accordingly, when the sheets SH1 and SH2 are fixed by the seal walls SW1 to SW4 as well as the dummy walls DW1 and DW2 each made of the adhesive material in the arrangement pattern shown in FIG. 6, the adhesive material need not be always arranged on the sheets as shown in FIGS. 3(A) and 3(B) in the adhesive material-supplying step. For example, the adhesive material may be arranged on the sheets SH1 and SH2 in the adhesive-material supplying step as follows.

(a) For example, the seal walls and dummy walls as the adhesive structures may be formed onto the sheets SH1 and SH2 as shown in FIGS. 8(A) and 8(B).

The dummy walls DW1 and DW2 are formed from the adhesive material on the sheet SH2. The seal walls SW1 to SW4 are formed from the adhesive material on the sheet SH1. Even when the adhesive material is arranged in this way on the sheets, the sheets SH1 and SH2 can be continuously fixed with the adhesive material in the pressure progression direction in the sheet-fixing step.

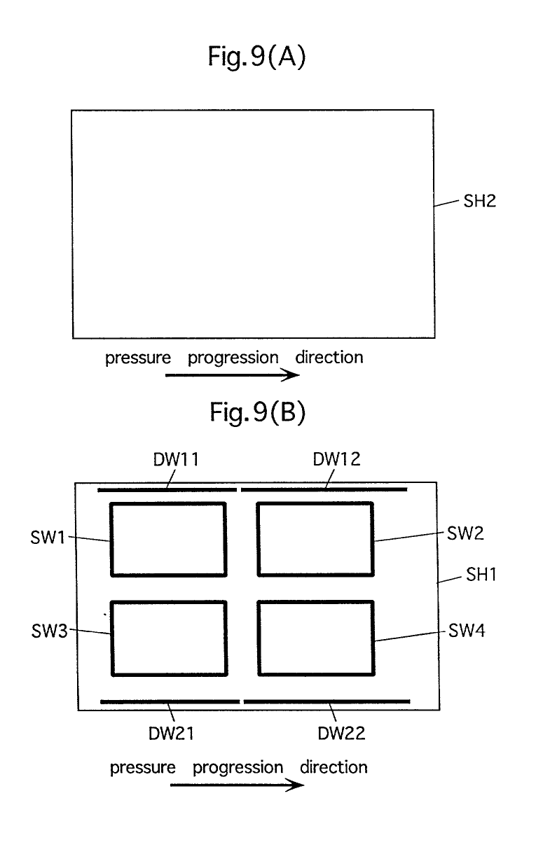

(b) The seal walls and dummy walls as the adhesive structures may be formed onto the sheets SH1 and SH2 using the adhesive material as shown in FIGS. 9(A) and 9(B).

The seal walls and dummy walls are not formed on the sheet SH2. The seal walls SW1 to SW4 as well as the dummy walls DW11 and DW12, DW21, DW22 are formed on the sheet SH1.

The seal walls SW1 to SW4 are formed on the sheet SH1 in the same arrangement pattern as in FIG. 3(B).

The dummy walls DW11 and DW12 are in a line form extending in the pressure progression direction and are neighboring to each other in the pressure progression direction. A small space or gap exists between the dummy walls DW11 and DW12 in a region between the seal walls SW1 and SW2 in the pressure progression direction. From another viewpoint, the dummy walls DW11 and DW12 are equivalent to a divided version of the dummy wall DW1 of FIG. 3(B).

The dummy walls DW21 and DW22 are in a line form extending in the pressure progression direction, are neighboring to each other in the pressure progression direction, and slightly spaced away from each other in the pressure progression direction like the dummy walls DW11, DW12.

Even if the adhesive material is arranged on the sheet SH1 in this way, the dummy walls DW11 and DW12 made of the adhesive material are slightly deformed and extended by the pressure exerted on the dummy walls in fixing the sheets, so that the space between the dummy walls DW11 and DW12 is filled up with the deformed dummy wall DW11 and/or DW12. Likewise the space between the dummy walls DW21 and DW22 is filled up with the deformed dummy wall DW21 and/or DW22.

Consequently even when the adhesive material is arranged on the sheets as described above, the adhesive material can continuously adhere to the sheets SH1 and SH2 in the sheet-fixing step.

### §6.

The shape, position, arrangement and others of the dummy wall formed onto the sheet using the adhesive material in the adhesive material-supplying step are not limited to those described hereinbefore.

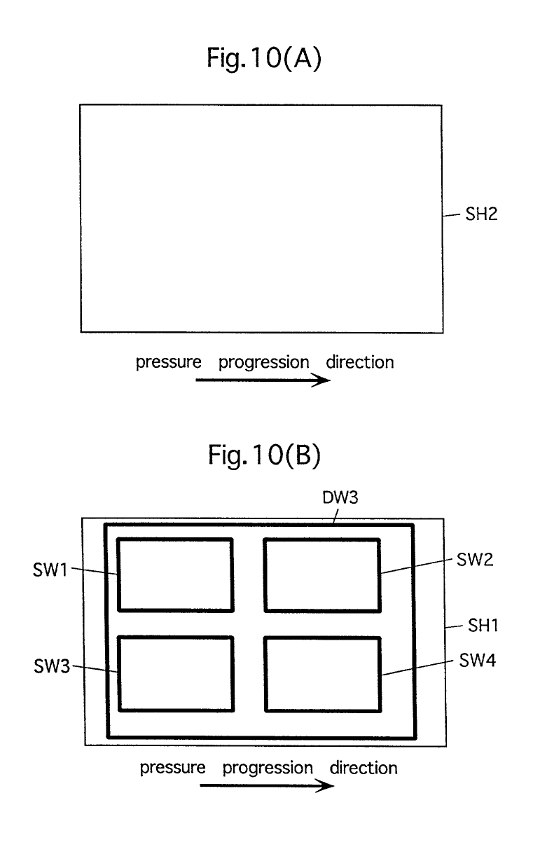

For example, a dummy wall DW3 as the adhesive structure may be formed using the adhesive material as shown in FIGS. 10(A) and 10(B). The dummy wall DW3 surrounds the seal walls SW1 to SW4 in their entirety.

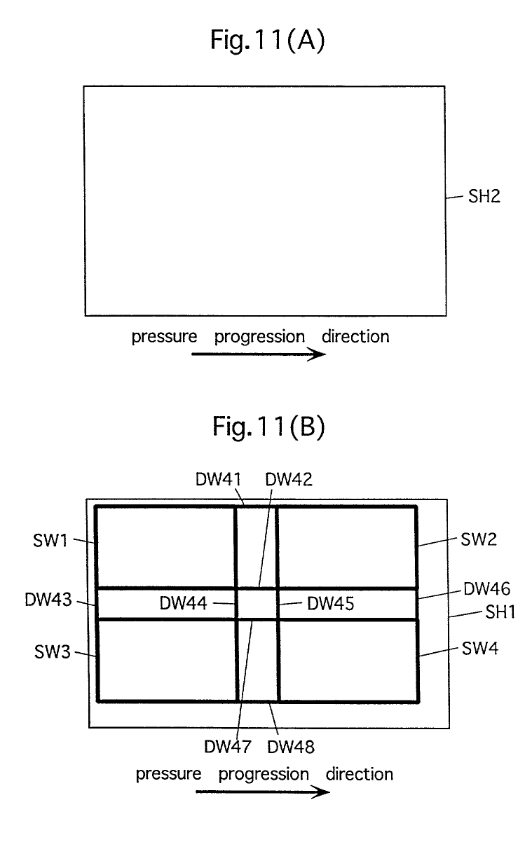

Or dummy walls DW41 to DW48 as the adhesive structures may be formed with the adhesive material as shown in FIGS. 11(A) and 11(B). Each of the dummy walls DW41 to DW48 is connected to at least one of the seal walls SW1 to SW4. The dummy walls DW41, DW43, DW46 and DW48 are formed on a line of an outer frame formed of four seal walls SW1 to SW4. The other dummy walls are formed inside the outer frame. Due to this structure, the seal walls SW1 to SW4 can be formed so as to occupy regions near four end of the sheet SH1 so that the region surrounded by each of the seal walls SW1 to SW4, and therefore each display region of the liquid crystal display elements can be broadened. Liquid crystal display elements each with a larger display region can be produced from sheets of the same size when seal walls and dummy walls are formed as shown in FIGS. 11(A) and 11(B) than when seal walls and dummy walls are formed as shown in FIGS. 3(A) and 3(B).

### §7.

In fixing the sheets, the adhesive material can continuously adhere to the sheets SH1 and SH2 in the pressure progression direction by employing a proper arrangement, shape and like factors of plural seal walls without forming the dummy wall.

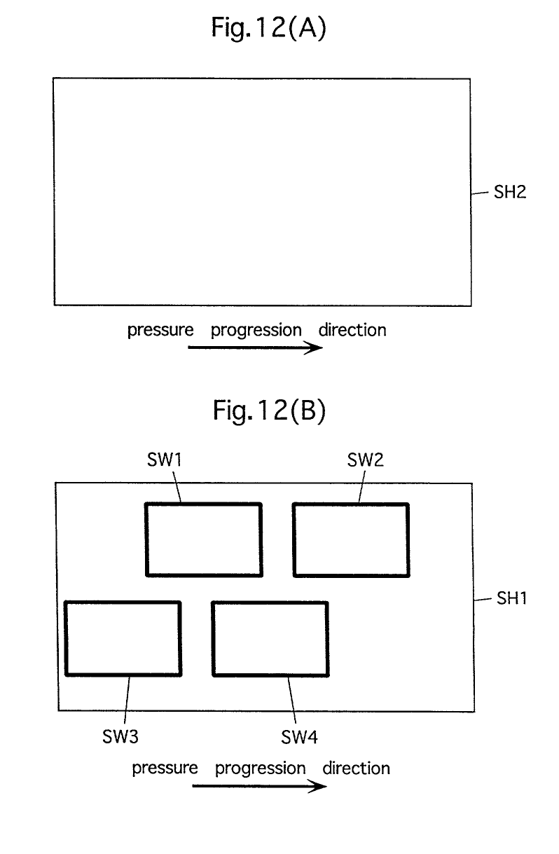

For example, the seal walls SW1 to SW4 made of the adhesive material may be arranged as shown in FIGS. 12(A) and 12(B).

The arrangement of seal walls SW1 to SW4 as the adhesive structures on the sheet SH1 in FIG. 12(B) is different from that of FIG. 3(B) as follows.

A position of a group of the seal walls SW1 and SW2 neighboring to each other in the pressure progression direction is shifted in the pressure progression from a position of a group of the seal walls SW3 and SW4 neighboring to each other in the pressure progression direction, so that a space between the seal walls SW1 and SW2 is filled up with the adhesive material composing the seal wall SW4, and a space between the seal walls SW3 and SW4 is filled up with the adhesive material composing the seal wall SW1.

Accordingly, the adhesive material can continuously adhere to the sheets in the pressure progression direction in the sheet-fixing step even if dummy walls are not formed on the sheets.

Even if the seal walls are arranged so as that the adhesive material can continuously adhere to the sheet without helping of the dummy wall as described above, the dummy wall may be formed.

### §8.

The manner for fixing the sheets in the sheet-fixing step are not limited to the manner of FIG. 5, and may be as follows.

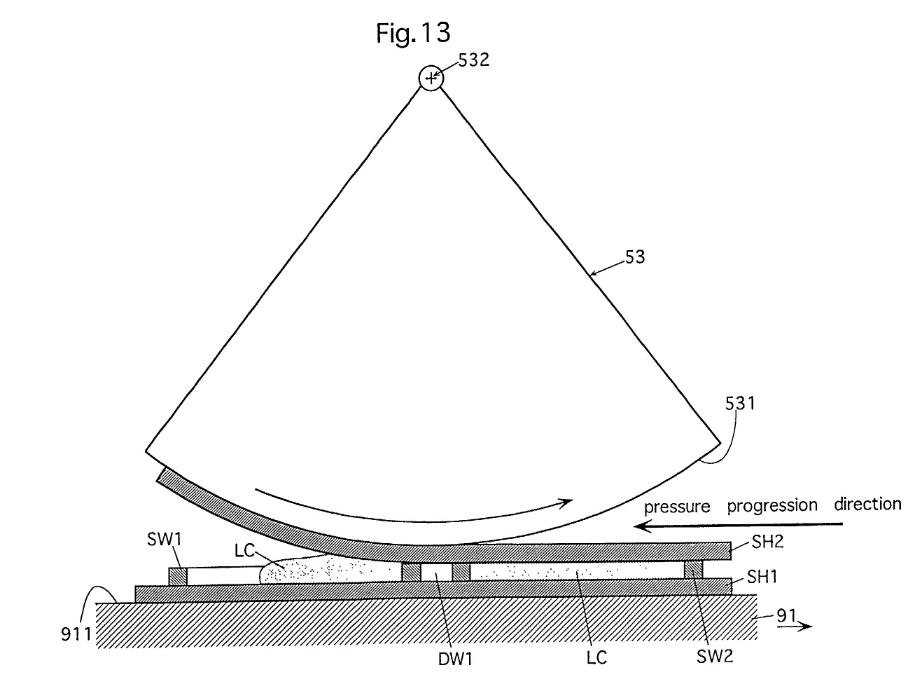

(a) For example, the sheets SH1 and SH2 may be fixed together, instead of using the pressing roller 51 of FIG. 5, in the following manner using a pressing member 53 shown in FIG. 13 which has a sector-like shape in section and has an arcing surface.

The sheet SH1 having the seal walls and dummy walls formed thereon is held by the flat table 91. The sheet SH2 is held by air-suction on a circumferential surface (arcing surface) 531 of the pressing member 53.

The pressing roller 53 is swung in a counterclockwise direction with a center of a fulcrum 532. The table 91 is moved rightwardly in FIG. 13 synchronously with the swing of the pressing member 53, whereby the sheets SH1 and SH2 are fixed together while applying a pressure from one end portion (right end portion in the figure) of the sheets to the other end portion thereof.

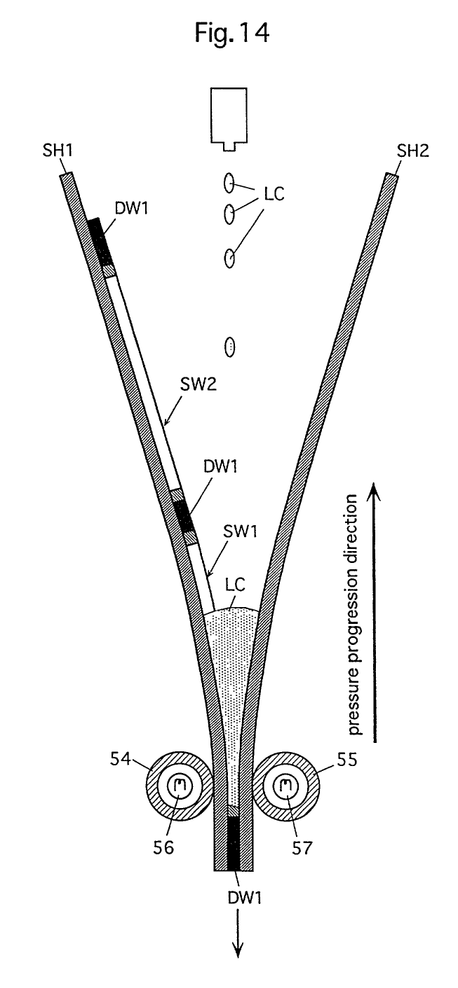

(b) The sheets SH1 and SH2 may be fixed together by passing, as shown in FIG. 14, through a pair of opposed rollers 54 and 55 from an upper side to a lower side as progressively superimposed over each other. The pressing rollers 54 and 55 are internally provided with heaters 56 and 57, respectively. The sheets SH1 and SH2 are fixed as pressed and heated.

In this case, the liquid crystal LC may be supplied onto the sheets SH1 and SH2 from a space between the sheets before and/or during the fixing operation. Spacers may be dispersed into the liquid crystal LC to be supplied onto the sheets SH1, SH2, instead of dispersing the spacers onto the sheet before fixing the sheets.

### §9.

In the foregoing description, the liquid crystal is filled into the space surrounded by the sheets and the seal wall by supplying the liquid crystal onto the sheet before and/or during the fixing operation. Instead of this, the liquid crystal may be filled into the space after fixing the sheets.

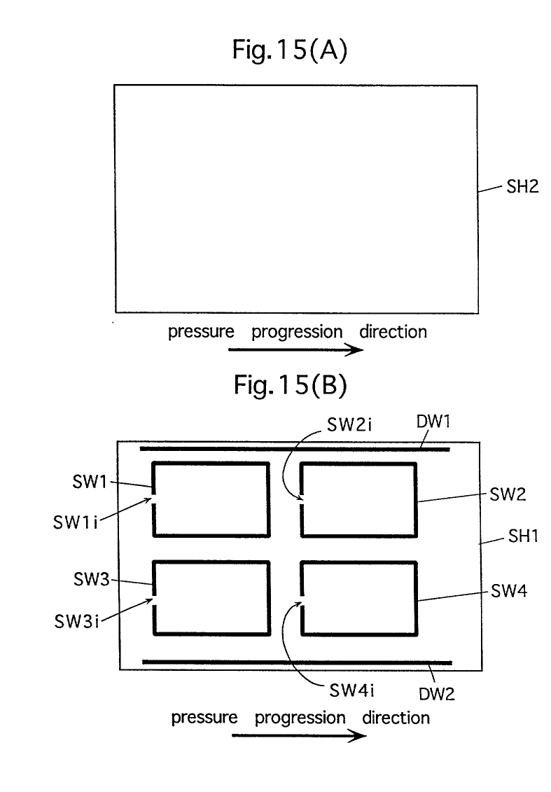

If the liquid crystal is to be filled into the space surrounded by the sheets (substrates) and the seal wall after fixing the sheets, the seal wall formed on the sheet in the adhesive material-supplying step may have, for example, an inlet port SW1i, SW2i, SW3i, or SW4i for entry of the liquid crystal as shown in FIGS. 15(A) and 15(B).

When the sheets are fixed with the seal walls SW1 to SW4 and dummy walls DW1, DW2 interposed therebetween without supplying the liquid crystal onto the sheet before fixing the sheets, there is obtained empty-liquid crystal display elements (empty cells) each in which the liquid crystal is not arranged in the space surrounded by the sheets and the seal wall. Even when the empty-liquid crystal display elements are produced, the manners for fixing the sheets as described before can be employed. Also, in this case, the seal walls and/or dummy wall(s) made of the adhesive material continuously adhere to the sheets in the pressure progression direction in the fixing step, so that the shift of positional relationship between the sheets and the partial bending of the sheet can be suppressed. In this case, the liquid crystal is filled into each the space surrounded by the sheets (substrates) and the respective seal walls, e.g. by a vacuum filling method after cutting the sheets SH1 and SH2 along the predetermined cut line(s) into individual sets of the empty-liquid crystal display elements. Or the liquid crystal is filled into each that space before cutting the sheets SH1 and SH2. After filling of the liquid crystal, the inlet port for entry of the liquid crystal may be sealed with a sealing material.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of producing a plurality of liquid crystal display elements, each of the liquid crystal display elements including a first substrate, a second substrate and a seal wall, the seal wall being arranged between the first and second substrates, being adhered to both of the first and second substrates and being provided for sealing a liquid crystal to be arranged between the first and second substrates, the method comprising:
(a) an adhesive structure forming step of forming at least one adhesive structure onto at least one of first and second sheets using at least one kind of adhesive material,
the first sheet including a plurality of portions that are to be the first substrates for the plurality of the liquid crystal display elements, the second sheet including a plurality of portions that are to be the second substrates for the plurality of the liquid crystal display elements, at least a portion of said at least one adhesive structure being to serve as the seal walls for the plurality of the liquid crystal display elements to be produced; and
(b) an adhering step of adhering the first and second sheets together with said at least one adhesive structure therebetween while applying a pressure along a predetermined pressure progression direction; wherein
said at least one adhesive structure occupies, at every position with respect to the pressure progression direction in a range from an upstream end thereof to a downstream end thereof, at least a part of a gap between the first and second sheets after performing the adhering step.

2. A producing method according to claim 1, wherein at least a portion of said at least one adhesive structure, formed in the adhesive structure forming step, is to be at least one dummy wall, the dummy wall not functioning as the seal wall.

3. A producing method according to claim 2, wherein at least the portion of said at least one adhesive structure to be serving as the seal walls and the portion of said at least one adhesive structure to be said at least one dummy wall are connected continuously before performing the adhering step.

4. A producing method according to claim 2, wherein a plurality of the adhesive structures are formed in the adhesive structure forming step, at least one of the adhesive structures is to be the dummy wall and is formed onto the first sheet, and the remaining adhesive structure(s) are to be serving as the seal walls and are formed onto the second sheet.

5. A producing method according to claim 1, wherein said at least one adhesive structure occupies, at the every position, at least the part of the gap between the first and second sheets before performing the adhering step.

6. A producing method according to claim 1, further comprising a liquid crystal supplying step of supplying the liquid crystal onto at least a portion of at least one of the first and second sheets, the liquid crystal supplying step being performed before adhering step, wherein
the first and second sheets are adhered together with said at least one adhesive structure and the liquid crystal therebetween in the adhering step.

7. A producing method according to claim 1, further comprising a liquid crystal filling step of filling the liquid crystal into each of spaces surrounded by each of the seal walls, the liquid crystal filling step being performed after the adhering step.

8. A producing method according to claim 1, wherein the pressure is applied, in the adhering step, to the first and second sheets using first and second pressing members opposed to each other.

9. A producing method according to claim 8, wherein the first pressing member has a columnar form or has an arcing surface, and is rotatable.

10. A producing method according to claim 9, wherein the second pressing member has a flat surface.

11. A producing method according to claim 8, wherein the first and second pressing members are a pair of rollers.

12. A producing method according to claim 8, wherein at least one of the first and second sheets has a flexibility.

13. A producing method according to claim 1, wherein at least one of the first and second sheets has a flexibility.
